(19) United States
(12) Patent Application Publication
(10) Pub. No.: US 2026/0229819 A1
(43) Pub. Date: Aug. 6, 2026

(54) QUICK CONNECT CONNECTOR

(71) Applicant: Charter Communications Operating, LLC, St. Louis, MO (US)

(72) Inventors: Colin Edward Downer-Carlson, Lakewood, CO (US); Ross Jay MacGregor, Erie, CO (US)

(21) Appl. No.: 19/043,859

(22) Filed: Feb. 3, 2025

(51) Int. Cl. H01R 13/629; H01R 13/502; H01R 13/622; H01R 103/00

(52) U.S. Cl. CPC H01R 13/629; H01R 13/502; H01R 13/622; H01R 2103/00

(57) ABSTRACT

A quick connect connector comprising a body, a coupling component, and a coupling nut assembly is disclosed. A longitudinal axis extends through the body, the coupling component and the coupling nut assembly. The coupling component comprises a base portion and a plurality of extensions and is connected to the body. The plurality of extensions have internal threads and are operable to pivot away from the longitudinal axis. The coupling nut assembly is slidably connected to the body and has an uncoupled position and a coupled position. In the uncoupled position, the coupling nut assembly allows the plurality of extensions to be pivoted away from the longitudinal axis. In the coupled position, an interior surface of the coupling nut assembly contacts the plurality of extensions to inhibit pivoting of the plurality of extensions away from the longitudinal axis.

### BACKGROUND

Threading one connector to another connector, such as, by way of non-limiting example, a male coaxial cable connector to a female coaxial cable connector, can be tedious and time-consuming, but it is important for the connectors to be joined together tightly. If the connectors connect a communication medium, such as a coaxial cable, a secure connection helps ensure a reliable electrical path, reduces resistance, and decreases the likelihood of the connectors becoming disconnected by vibrations or other environmental conditions.

### SUMMARY

The implementations disclosed herein provide for a quick connect connector.

In one implementation, a quick connect connector is provided. The quick connect connector includes a body, a coupling component and a coupling nut assembly. A longitudinal axis extends through the body, the coupling component and the coupling nut assembly, and the coupling component is connected to the body. The coupling component includes a base portion and a plurality of extensions that extend from the base portion, the plurality of extensions having internal threads and being operable to pivot away from the longitudinal axis. The coupling nut assembly is slidably connected to the body and has an uncoupled position wherein the coupling nut assembly allows the plurality of extensions to be pivoted away from the longitudinal axis and a coupled position wherein an interior surface of the coupling nut assembly contacts the plurality of extensions to inhibit pivoting of the plurality of extensions away from the longitudinal axis.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is an exploded view of a quick connect connector according to one implementation;

FIG. 2 is a cross-sectional view of the quick connect connector taken along line A-A of the quick connect connector according to one implementation;

FIG. 3A is a first perspective view of a coupling component of the quick connect connector according to one implementation;

FIG. 3B is a second perspective side view of the coupling component of the quick connect connector according to one implementation;

FIGS. 4A – 4C are cross-sectional views of the quick connect connector illustrating a coupling nut assembly at different positions with respect to the coupling component according to one implementation;

FIG. 5A is cross-sectional view of the quick connect connector taken along line B-B illustrating the coupling nut assembly in an uncoupled position according to one implementation;

FIG. 5B is a cross-sectional view of the quick connect connector taken along line C-C subsequent to being slid to a coupled position according to one implementation;

FIG. 5C is a cross-sectional view of the quick connect connector taken along line D-D subsequent to being slid to the coupled position according to one implementation;

FIG. 5D is a cross-sectional view of the quick connect connector taken along line E-E subsequent to being slid to the coupled position according to one implementation; and

FIGS. 6A – 6C illustrate the quick connect connector at various positions as the quick connect connector is being connected to a corresponding connector.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Threading one connector to another connector, such as, by way of non-limiting example, a male coaxial cable connector to a female coaxial cable connector, can be tedious and time-consuming, but it is important for the connectors to be joined together tightly. If the connectors connect a communication medium, such as a coaxial cable, a secure connection helps ensure a reliable path, reduces resistance, and decreases the likelihood of the connectors becoming disconnected by vibrations or other environmental conditions.

In practice, threading two connectors can be sufficiently tedious and time-consuming that the individual threading the connectors may not be sufficiently patient to tighten the two connectors, resulting in a poor connection. Sometimes the connectors may be located in a relatively confined location in proximity to other surfaces such that rotation of a connector can be difficult or even cause physical discomfort as the individual’s fingers contact adjacent hard and/or uneven surfaces during the threading (e.g., screwing) process. Technicians who, as part of their job, repeatedly thread connectors can spend a substantial amount of time on a daily basis threading connectors.

The examples disclosed herein provide a quick connect connector for ensuring a stable and secure connection between two threaded connectors. The quick connect connector has a longitudinal axis that extends through a body, a coupling component, and a coupling nut assembly. The coupling component is connected to the body and includes a base portion and a plurality of extensions that extend from the base portion. The plurality of extensions have internal threads and are operable to pivot away from the longitudinal axis. The coupling nut assembly is slidably connected to the body and has an uncoupled position in which the coupling nut assembly allows the plurality of extensions to pivot away from the longitudinal axis. The coupling nut assembly also has a coupled position in which an interior surface of the coupling nut assembly contacts the plurality of extensions to inhibit pivoting of the plurality of extensions away from the longitudinal axis.

With the coupling nut assembly in the uncoupled position the coupling component can be pushed/urged over an externally threaded connector that has threads that match those of the coupling component. The extensions may or may not be manufactured to have an inward bias toward the longitudinal axis. As the extensions contact the external threads of the externally threaded connector the extensions can pivot to allow the internal threads of the extensions to move past the external threads of the externally threaded connector without a need to rotate the coupling component. When the coupling component is urged to a point where forward movement is inhibited, the internal threads of the coupling component are mated with the external threads of the externally threaded connector. The coupling nut assembly can be slidably moved to the coupled position wherein the interior surface of the coupling nut assembly contacts the plurality of extensions to inhibit pivoting of the plurality of extensions away from the longitudinal axis. In a coaxial cable connector implementation, a secure electrical contact will be established with the externally threaded connector. In some implementations, the coupling nut assembly may then be rotated sufficiently to further secure the quick connect connector to the externally threaded connector.

Among other advantages, the examples disclosed herein entirely or almost entirely eliminate the need to thread (i.e., screw) an internally threaded connector to an externally threaded connector while ensuring that the final connection between the two components is secure.

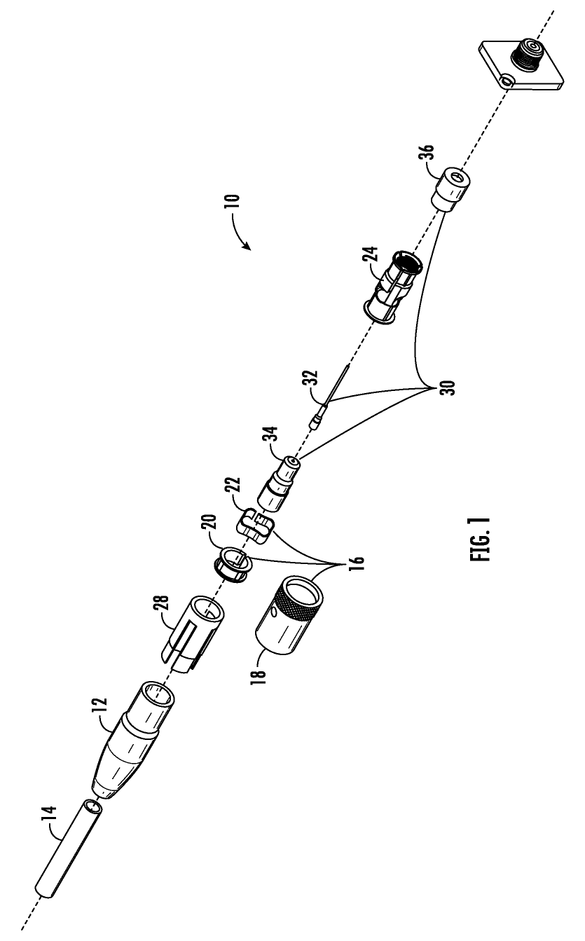

FIG. 1 is an exploded view of a quick connect connector 10 according to one implementation. The quick connect connector 10 includes a body 12. In some implementations the body 12 may be joined to an external component 14, which, in this example, is a coaxial cable. While solely for purposes of illustration, the quick connect connector 10 is illustrated throughout the drawings as a male coaxial connector, the examples disclosed herein are not limited to coaxial connectors and indeed have applicability to any threaded connectors. Moreover, in some implementations the quick connect connector 10 may comprise multiple center pins and corresponding conductors.

The quick connect connector 10 includes a coupling nut assembly 16 that includes a casing 18, an inner ring 20, and a spring 22. As discussed in greater detail below, the casing 18 may enclose the inner ring 20 and the spring 22, and the spring 22 may be located between the casing 18 and the inner ring 20.

The quick connect connector 10 includes a coupling component 24 that is operable to engage with a corresponding externally threaded connector. In a coaxial cable connector implementation, a crimp sleeve 28 may be coupled to the coupling component 24 and to a braided shield (not illustrated) of the external component 14 to establish electrical connectivity between the coupling component 24 and the external component 14.

In this example, the quick connect connector 10 includes a pin assembly 30 that includes a center pin 32 (e.g., inner conductor/center conductor), a pin cover 34, and a retainer 36. As discussed in greater detail below, the center pin 32 is encased by the pin cover 34 to stabilize the center pin 32. The retainer 36 facilitates further stabilization of the pin cover 34 when the quick connect connector 10 is connected to the externally threaded connector and may facilitate shielding of the center pin 32. The center pin 32, the pin cover 34, and the retainer 36 are housed within the coupling component 24. The center pin 32 can engage with the externally threaded connector to establish an electrical path between the external component 14 electrically coupled to the quick connect connector 10 and the externally threaded connector.

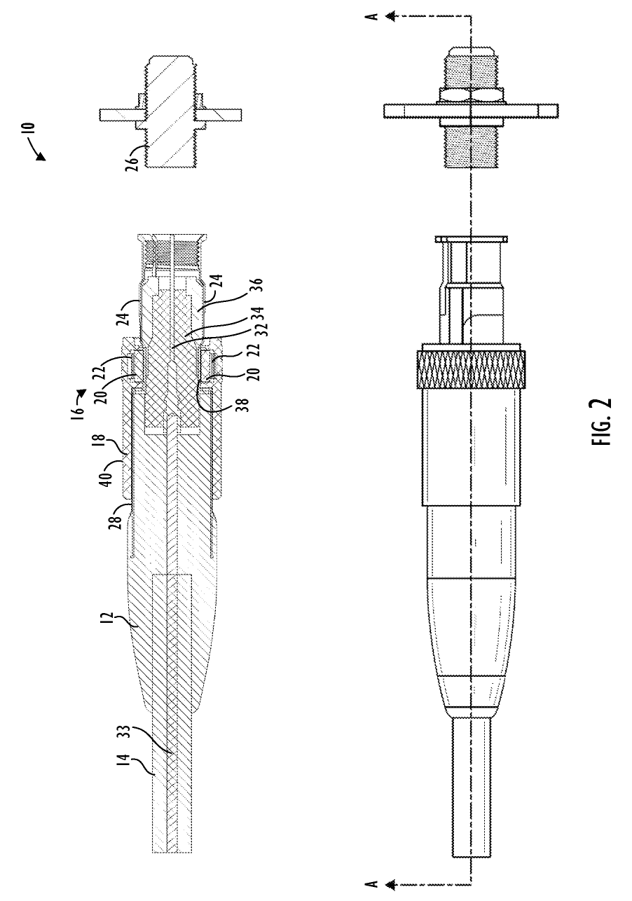

FIG. 2 is a cross-sectional view of the quick connect connector 10 taken along line A-A of the quick connect connector 10 according to one implementation. The quick connect connector 10 is operable to connect to an externally threaded matching connector 26, in this example, a female coaxial connector. Note that the terms “male” and “female” are used herein as they are conventionally used when discussing coaxial connectors. In other implementations, the quick connect connector 10 may be referred to as the female connector since the quick connect connector 10 receives the matching externally threaded connector 26.

The pin assembly 30 can engage with the externally threaded connector 26 via the center pin 32 to connect with the externally threaded connector 26. The center pin 32 is electrically coupled to a center core 33 of the external component 14. The center pin 32 may comprise a conductive material such as, by way of example, brass, silver, copper, gold, or the like. The quick connect connector 10 can operate to connect to an externally threaded connector 26 of varying types, including, but not limited to F-Type connectors, TNC connectors, N-Series connectors, UHF connectors, SMA and SMB connectors, QMA connectors, FME connectors, and the like. The quick connect connector 10 can have any suitable diameter and pin assembly 30 configuration suitable to couple with female connectors of the aforementioned types.

The coupling nut assembly 16 includes an interior surface 38 and an exterior surface 40. The interior surface 38 is defined by the inner ring 20 and the exterior surface 40 is defined by the casing 18. The coupling nut assembly 16 is slidably connected to the body 12 to enable the coupling nut assembly 16 to slide across a surface the body 12, including the crimp sleeve 28 and the coupling component 24. The term “connected” as used herein refers to either a direct coupling between two components or an indirect coupling via one or more intermediate components. In one implementation, the coupling nut assembly 16 is directly slidably coupled to the coupling component 24 and slidably connected to the body 12 via the coupling component 24.

The center pin 32 of the pin assembly 30 electrically couples the external component 14 to a matching component of the externally threaded connector 26. The pin cover 34 encases the center pin 32 and protects and stabilizes the center pin 32. The center pin 32 is partially exposed to enable the center pin 32 to engage with the matching component of the externally threaded connector 26. In some implementations, the pin cover 34 comprises an electrically inert material, such as plastic. The retainer 36 may comprise a metallic shielding material, such as brass, steel or other ferrous metal.

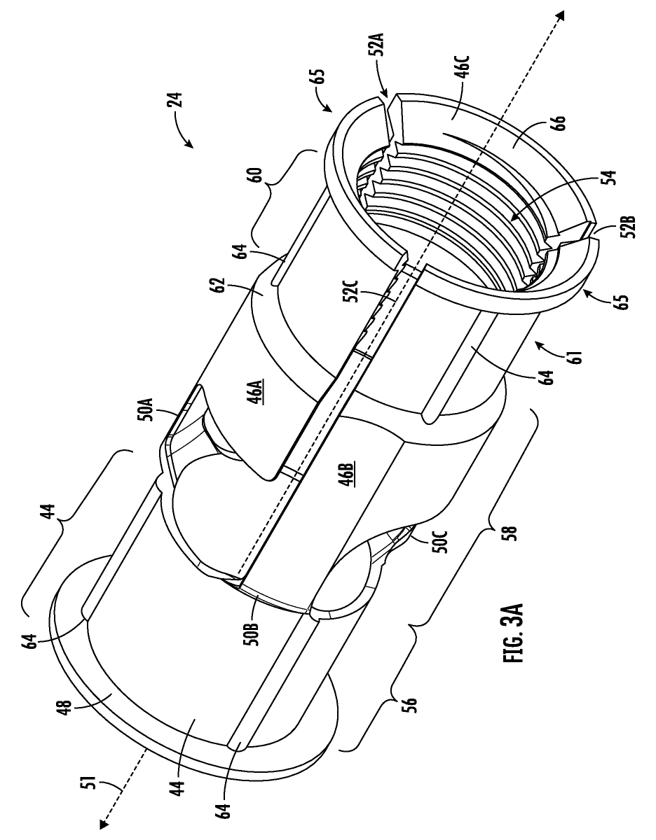

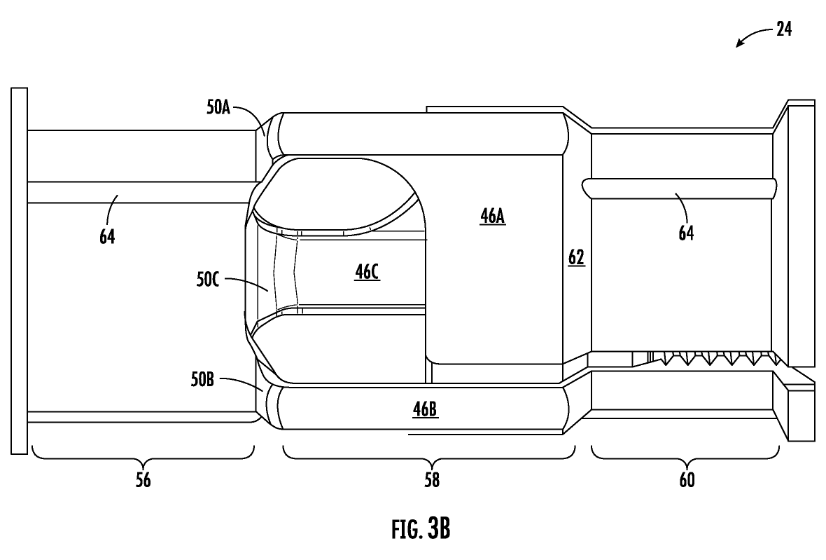

FIG. 3A is a first perspective view of the coupling component 24 according to one implementation. The coupling component 24 includes a base portion 44 and a plurality of extensions 46A, 46B, 46C (generally, extensions 46). While solely for purposes of illustration FIG. 3A illustrates three extensions 46, the examples may be implemented with two extensions 46, or a number of extensions 46 greater than three. Each extension 46 connects with the base portion via corresponding connection links 50A – 50C (generally, connection links 50). The connection links 50 permit the extensions 46 to pivot with respect to the base portion 44. The plurality of extensions 46 can pivot away from and/or towards a longitudinal axis 51 that extends through the quick connect connector 10. The longitudinal axis 51 may be colinear with the center pin 32. A plurality of gaps 52A, 52B, and 52C (generally, gaps 52) separates at least a portion of the extensions 46.

An exterior diameter of the coupling component 24 may vary along a length of the coupling component 24. For example, an exterior diameter of the coupling component 24 may be less at a section 56 of the coupling component 24 than an exterior diameter of a section 58 of the coupling component 24. The exterior diameter of the section 58 may be greater than an exterior diameter of a section 60 of the coupling component 24. The section 60 may form an annular recess 61 that, as will be discussed in greater detail herein, receives the inner ring 20 as the coupling nut assembly 16 is slid to a coupled position.

Threaded internal surfaces 54 of the extensions 46 have a thread that threadedly matches an external thread of the externally threaded connector 26. In some implementations, the retainer 36 (FIG. 1) may be sized to limit the inward pivoting of the extensions 46, setting a minimum interior diameter of the threaded interior surface 54 of the coupling component 24 substantially equal to a diameter of the retainer 36. The diameter of the retainer 36 may be sized to allow the threaded internal surfaces 54 to engage the external threads of the externally threaded connector 26. In some implementations, when coupled, as described in greater detail below, the threaded internal surfaces 54 may contact, by way of non-limiting example, more than 40% of a circumference of the externally threaded connector 26 or more than 60% of a circumference of the externally threaded connector 26.

In some implementations, the coupling component 24 may include one or more protrusions 64 on the base portion 44 and/or the plurality of extensions 46. As will be described in greater detail below, in an implementation wherein the coupling nut assembly 16 (FIG. 1) is rotatable, the protrusions 64 can be sized to prevent the coupling component 24 from being over torqued.

In some implementations, the plurality of extensions 46 have an end portion 65 that includes chamfered interior surfaces 66 that slope away from the longitudinal axis 51. The chamfered interior surfaces 66 are unthreaded. As the coupling component 24 is urged in a forward direction toward the externally threaded connector 26, the chamfered interior surfaces 66 may contact the externally threaded connector 26. Further urging of the coupling component 24 in the forward direction causes the plurality of extensions 46 to pivot away from the longitudinal axis 51. As the coupling component 24 is continually urged in the forward direction the plurality of extensions 46 may iteratively pivot away from the longitudinal axis 51 and pivot back toward the longitudinal axis 51 as the threads of the threaded internal surfaces 54 ride over the threads of the externally threaded connector 26 and then drop in between the threads of the externally threaded connector 26, eliminating the need to screw the coupling component 24 to the externally threaded connector 26.

FIG. 3B is a second perspective view of the coupling component 24 according to one implementation.

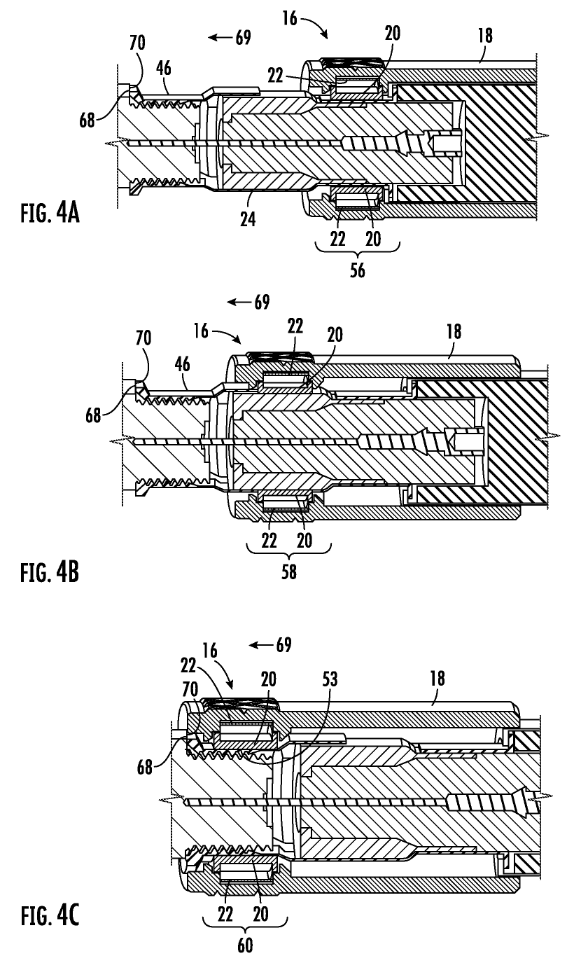

FIGS. 4A – 4C are cross-sectional views of the quick connect connector 10 illustrating the coupling nut assembly 16 at different positions with respect to the coupling component 24 according to one implementation. Referring first to FIG. 4A, the coupling component 24 has been connected to the externally threaded connector 26 as described above with regard to FIG. 3A. In particular, a user, such as a technician, grasps the body 12 and urges the quick connect connector 10 toward the externally threaded connector 26 in a forward direction 69. As the chamfered interior surfaces 66 contact the externally threaded connector 26, and the technician continues to urge the body 12 in the forward direction 69, the extensions 46 pivot away from the longitudinal axis 51 allowing the threads of the threaded internal surfaces 54 to ride over the threads of the externally threaded connector 26. When subsequent forward movement is inhibited, such as for example, when an end surface 68 of the coupling component 24 contacts a surface 70 of the externally threaded connector 26, the threads of the threaded internal surfaces 54 drop in between the threads of the externally threaded connector 26 due to the sloped surfaces of the threads. In FIG. 4A the coupling nut assembly 16 is in an uncoupled position such that the coupling nut assembly 16 allows (e.g., does not inhibit) the extensions 46 to pivot away from the longitudinal axis 51 (FIG. 3A).

FIG. 4B illustrates the coupling nut assembly 16 in a transition position as the coupling nut assembly 16 is slid from the uncoupled position toward the coupled position. The inner ring 20 contacts the section 58 (FIG. 3A) of the coupling component 24. When in the transition position, the coupling nut assembly 16 inhibits pivoting of the plurality of extensions 46 away from the longitudinal axis. To position the coupling nut assembly 16 in the transition position the technician grasps the coupling nut assembly 16 and urges the coupling nut assembly 16 in the forward direction 69. The coupling nut assembly 16 is slidably connected to the body 12 and slides along the body 12 and part way across the coupling component 24. The coupling nut assembly 16 thereby transitions from the uncoupled position to the transition position. In the transition position, the inner ring 20 of the coupling nut assembly 16 contacts the extensions 46.

In some implementations, to accommodate the changing diameter of the external surface of the extensions 46, the inner ring 20 may contain a gap that allows the inner ring 20 to expand and contract as the inner ring 20 is urged over the varying diameter surface of the extensions 46. The inner ring 20 may be elastic such that the inner ring 20 naturally attempts to return to a non-expanded size. The spring 22 can be a wave spring that applies a force to the inner ring 20 that urges the inner ring 20 to remain in a contracted state (e.g., a smaller diameter state) but allows the inner ring 20 to expand as the inner ring 20 is urged over the varying diameter surface of the extensions 46. As the inner ring 20 moves from the uncoupled position to the transition position the inner ring 20 expands in response to moving from the smaller diameter of the section 56 to the larger diameter of the section 58.

Referring now to FIG. 4C, the coupling nut assembly 16 is illustrated in a coupled position wherein an interior surface 53 of the coupling nut assembly 16 contacts the plurality of extensions 46 to inhibit pivoting of the plurality of extensions 46 away from the longitudinal axis 51 to thereby ensure a secure contact between the threaded internal surfaces 54 and the externally threaded connector 26. In this example, the interior surface 53 is an interior surface of the inner ring 20. To position the coupling nut assembly 16 in the coupled position the technician grasps the coupling nut assembly 16 and urges the coupling nut assembly 16 in the forward direction 69. The coupling nut assembly 16 is slidably connected to the body 12 and slides across the body 12 and across the coupling component 24. The coupling nut assembly 16 thereby transitions from the uncoupled position to the coupled position. In the coupled position, the inner ring 20 of the coupling nut assembly 16 contacts the extensions 46. When in the coupled position, the coupling nut assembly 16 inhibits pivoting of the plurality of extensions 46 away from the longitudinal axis 51.

As the inner ring 20 reaches the section 60 that contains the annular recess 61, the inner ring 20 contracts into the annular recess 61 and provides tactile feedback indicating that the coupling nut assembly 16 is now in the coupled position.

The inner ring 20 applies an inward force to the plurality of extensions 46 when the coupling nut assembly 16 is in the coupled position to inhibit or otherwise hinder pivoting of the extensions 46 away from the longitudinal axis 51. The spring 22 also imparts an inward force to the inner ring 20 to cause the inner ring 20 to apply the inward force to the plurality of extensions 46. Due to the annular recess 61, the inner ring 20 cannot easily slide in a direction opposite to the forward direction 69 without an outward force, such as might be imparted by a technician.

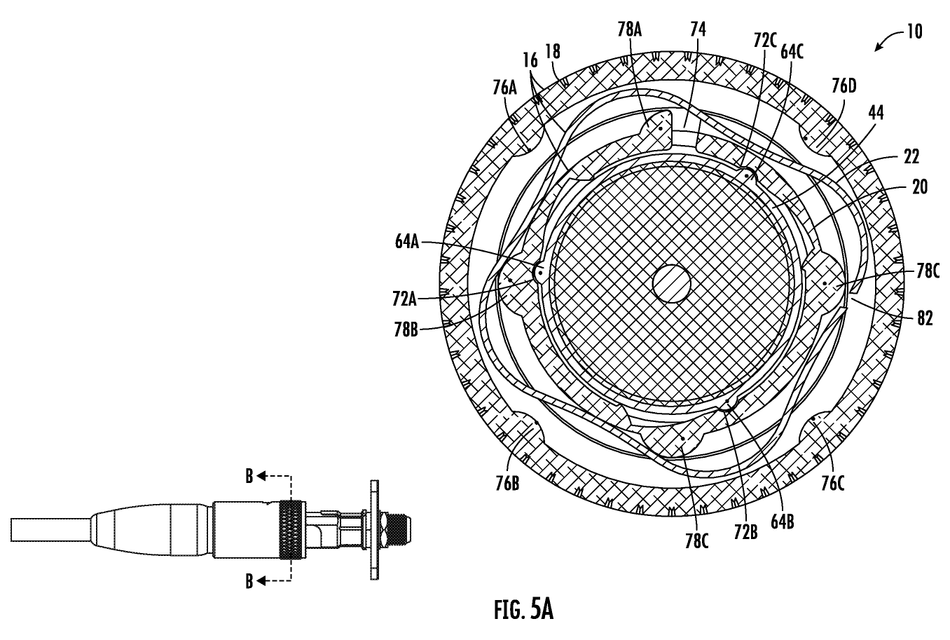

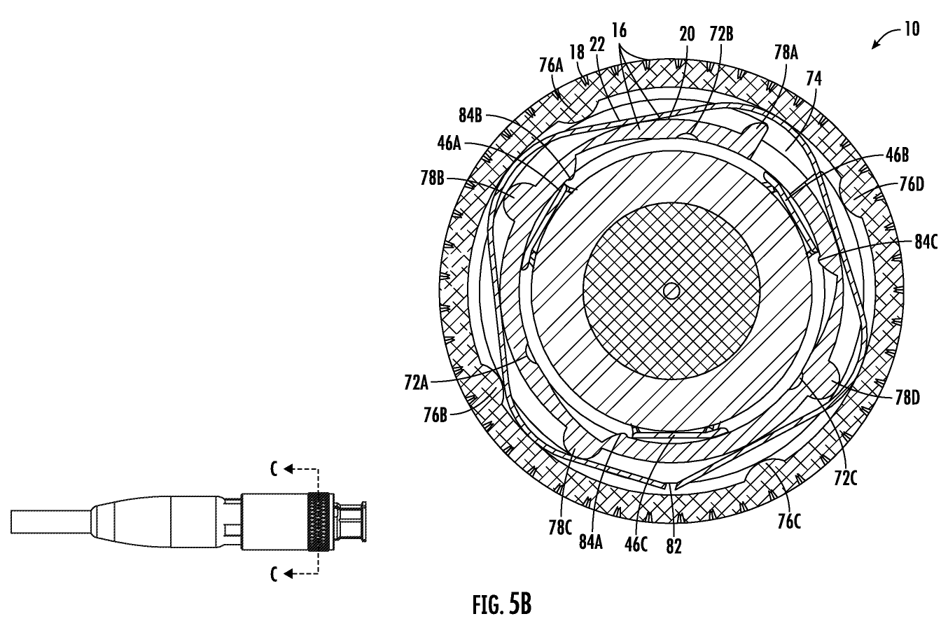

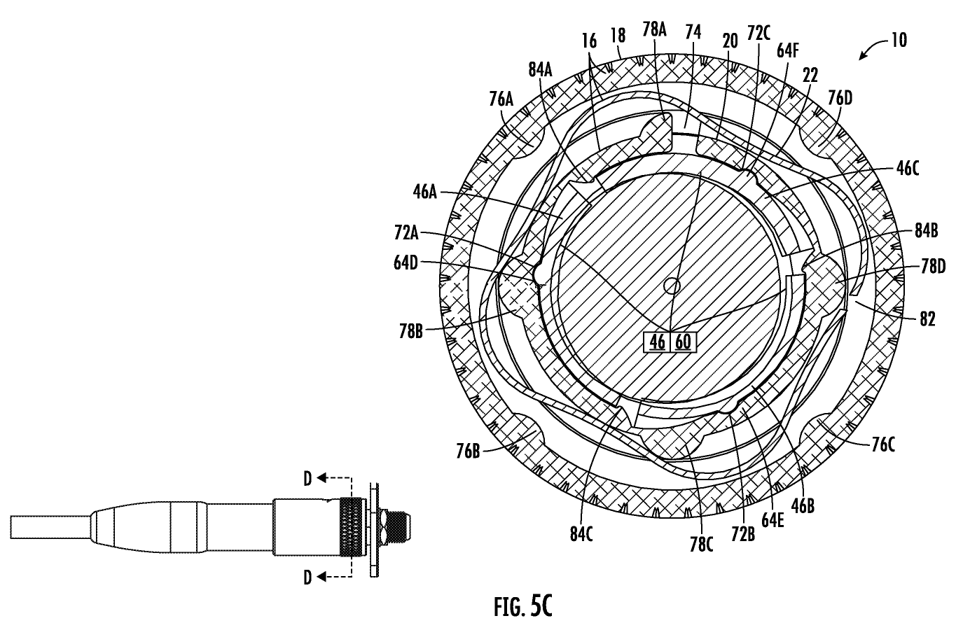

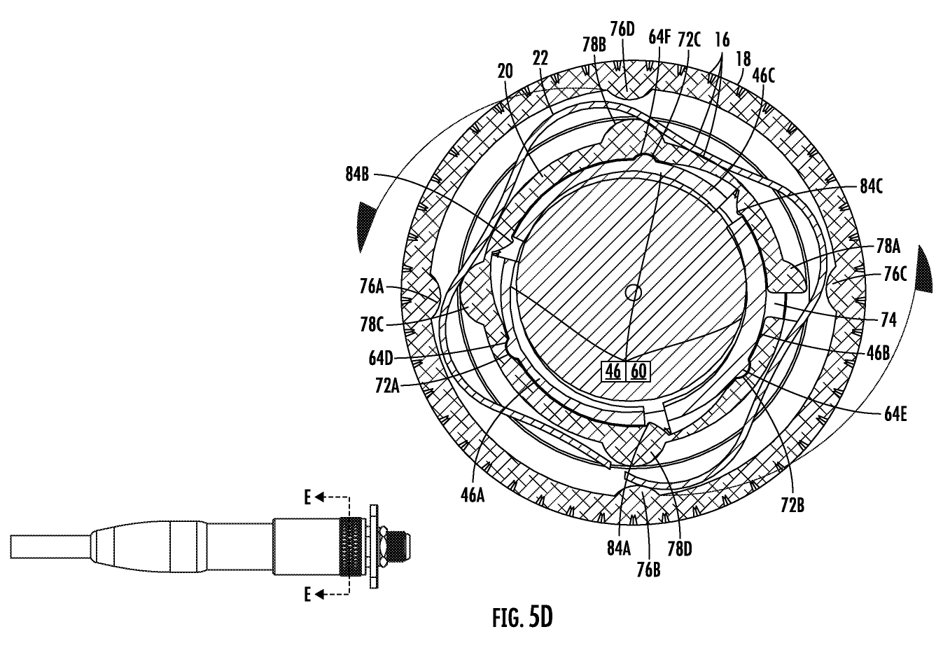

FIGS. 5A-5D are cross-sectional views of the quick connect connector 10 according to one implementation. FIG. 5A is a cross-section of the quick connect connector 10 taken along a line B-B with the coupling nut assembly 16 in the uncoupled position wherein the inner ring 20 contacts the section 56 (FIG. 3A) of the coupling component 24. As will be discussed in greater detail below, in some implementations the coupling nut assembly 16 is operable to rotate with respect to the body 12. The inner ring 20 contacts the coupling component 24 but is not affixed to the coupling component 24. In some implementations, the coupling nut assembly 16 is operable to enter a latched position with the coupling component 24. The inner ring 20 may form recesses 72A, 72B, and 72C (generally, recesses 72) that are sized to receive protrusions 64A, 64B, and 64C (generally, protrusions 64) of the coupling component 24. While the coupling nut assembly 16 is in the uncoupled position, the recesses 72 may interlock with the protrusions 64 on the base portion 44 of the coupling component 24. The interlock between the recesses 72 and the protrusions 64 can act as a guide for the coupling nut assembly 16 as the coupling nut assembly 16 slides across the coupling component 24 to prevent the coupling nut assembly 16 from easily rotating with respect to the body 12. When the protrusions 64 interlock with the recesses 72, the coupling nut assembly 16 is in the latched position with the coupling component 24. Additionally, or alternatively, the interlock prevents the coupling nut assembly 16 from easily rotating with respect to the body 12 and the coupling component 24.

While in the uncoupled position, the inner ring 20 may not contact the plurality of extensions 46, allowing the plurality of extensions 46 to pivot away from the longitudinal axis 51 if sufficient force is imparted on the extensions 46, or if the extensions 46 are designed to automatically pivot away from the longitudinal axis 51.

FIG. 5B is a cross-section of the quick connect connector 10 taken along a line C-C with the coupling nut assembly 16 in the transition position wherein the inner ring 20 contacts the section 58 (FIG. 3A) of the coupling component 24. In this implementation the section 58 lacks protrusions and thus while the inner ring 20 is in contact with the section 58, the recesses 72 are not interlocked with the protrusions 64. Edges of the plurality of extensions 46 contact catches 84A, 84B, and 84C (generally, catches 84) to facilitate sliding of the coupling nut assembly 16 along the coupling component 24 and to inhibit rotation of the coupling nut assembly 16 with respect to the body 12.

While positioned in the section 58, the inner ring 20 has expanded and has a larger gap 74 than the gap 74 illustrated in FIG. 5A, and therefore has a larger diameter than that illustrated in FIG. 5A, due to the larger external diameter of the section 58 compared to the external diameter of the section 56. The spring 22 continues to apply an inward force to the inner ring 20, and by extension to the plurality of extensions 46 so that, while the coupling nut assembly 16 is in the transition position, the plurality of extensions 46 are inhibited from pivoting away from the longitudinal axis.

FIG. 5C is a cross-section of the quick connect connector 10 taken along a line D-D with the coupling nut assembly 16 in the coupled position wherein the inner ring 20 contacts the section 60 (FIG. 3A) of the coupling component 24. When the inner ring 20 transitions from contacting the section 58 to contacting the section 60, the gap 74 of the inner ring 20 decreases as the diameter of the inner ring 20 decrease when the inner ring 20 contacts the section 60, the inner ring 20 applies a force onto the extensions 46 that have the threaded internal surface 54 engaging with the externally threaded connector 26 that urge the plurality of extensions 46 to pivot radially inward towards the longitudinal axis. In some implementations, the quick connect connector 10 is now secure with respect to the externally threaded connector 26.

In some implementations the recesses 72 are now interlocked with the protrusions 64 and the coupling nut assembly 16 is rotatable with respect to the body 12. If desired, the technician may rotate the coupling nut assembly 16 to provide a final tightening connection of the coupling nut assembly 16 to the externally threaded connector 26. Because the coupling nut assembly 16 is interlocked with the coupling component 24 via the recesses 72 and the protrusions 64, the coupling component 24 rotates along with the externally threaded connector 26 (as does the entire body 12 since the coupling component 24 may be non-rotatably fixed to the body 12). As the coupling component 24 turns the threaded internal surface 54 progresses along the externally threaded connector 26 similar to a conventional threaded connector until a desired resistance is met and the technician determines that the quick connect connector 10 is sufficiently tightened with respect to the externally threaded connector 26.

FIG. 5D is a cross-section of the quick connect connector 10 taken along a line E-E with the coupling nut assembly 16 in the coupled position wherein the inner ring 20 contacts the section 60 (FIG. 3A) of the coupling component 24. In some implementations the recesses 72 are now interlocked with the protrusions 64 and the coupling nut assembly 16 is rotatable with respect to the body 12. If desired, the technician may rotate the coupling nut assembly 16 to provide a final tightening connection of the coupling nut assembly 16 to the externally threaded connector 26. Because the coupling nut assembly 16 is interlocked with the coupling component 24 via the recesses 72 and the protrusions 64, the coupling component 24 rotates along with the externally threaded connector 26 (as does the entire body 12 since the coupling component 24 may be non-rotatably fixed to the body 12). As the coupling component 24 turns the threaded internal surface 54 progresses along the externally threaded connector 26 similar to a conventional threaded connector until a desired resistance is met and the technician determines that the quick connect connector 10 is sufficiently tightened with respect to the externally threaded connector 26.

As a technician applies a rotational force to the coupling nut assembly 16, the first detents 76 of the casing 18 contact the spring 22. The spring 22 can rotate with the casing 18 to contact the second detents 78 of the inner ring 20. The inner ring 20 can then rotate together with the coupling component 24 so that the entire coupling nut assembly 16 rotates. When the protrusions 64 of the coupling component 24 are interlocked with the recesses 72 such that the coupling nut assembly 16 is in the latched position with the coupling component 24, rotation of the coupling nut assembly 16 causes the coupling component 24 to rotate together with the coupling nut assembly 16. Rotation of the coupling component 24 causes the coupling component 24 to tighten its threaded connection with the externally threaded connector 26. After the coupling component 24 is fully threaded to the externally threaded connector 26, the coupling component 24 is no longer rotatable and the technician determines that the quick connect connector 10 is sufficiently tightened with respect to the externally threaded connector 26.

In some implementations, it may be desirable to provide tactile feedback indicating that the connection is sufficiently secure and to prevent over torquing of the coupling component 24. In such implementations, the recesses 72 and the protrusions 64 can be designed to separate at a particular torque threshold, allowing the coupling nut assembly 16 to continue to rotate with respect to the coupling component 24, preventing the coupling component 24 from further rotation, and upon separation providing tactile feedback to the technician. The desired over-torque threshold can be designed via any number of characteristics of the recesses 72 and the protrusions 64, including the number of recesses 72 and protrusions 64, the size of the recesses 72 and protrusions 64, the shape of the recesses 72 and protrusions 64, the length of the recesses 72 and protrusions 64, and the like.

In such an implementation, as the technician continues to apply rotational force to the coupling nut assembly 16, the torque threshold is ultimately exceeded. The protrusions 64 then break from the interlock with the recesses 72, allowing the coupling nut assembly 16 to rotate with respect to the body 12 and the coupling component 24 to cause the inner ring 20 to decrease in diameter. In some implementations, the spring 22 can also decrease in diameter, such that the first detents 76 can no longer contact the spring 22, resulting in the casing 18 being rotatable with respect to the inner ring 20.

In some implementations, the quick connect connector 10 can be removed from the externally threaded connector 26 by rotating the coupling nut assembly 16 in the opposite direction (e.g., in a counter clockwise direction) to reengage the protrusions 64 with the recesses 72. The coupling nut assembly 16 can continue to be rotated in the opposite direction, wherein the catches 84 engage with the plurality of extensions 46 so the coupling component 24 can be unthreaded from the externally threaded connector 26.

In some implementations, the extensions 46 may be engineered to have a naturally occurring position, via elasticity, wherein an internal radius of the threaded internal surfaces 54 are greater than that of an external diameter of the externally threaded connector 26. In such implementations, the coupling nut assembly 16 may simply be slid across the coupling component 24 in the reverse direction from the coupled position to the uncoupled position, at which point the extensions 46 automatically pivot away from the longitudinal axis 51 and thus separate from the externally threaded connector 26 allowing the quick connect connector 10 to be removed by pulling the quick connect connector 10 away from the externally threaded connector 26.

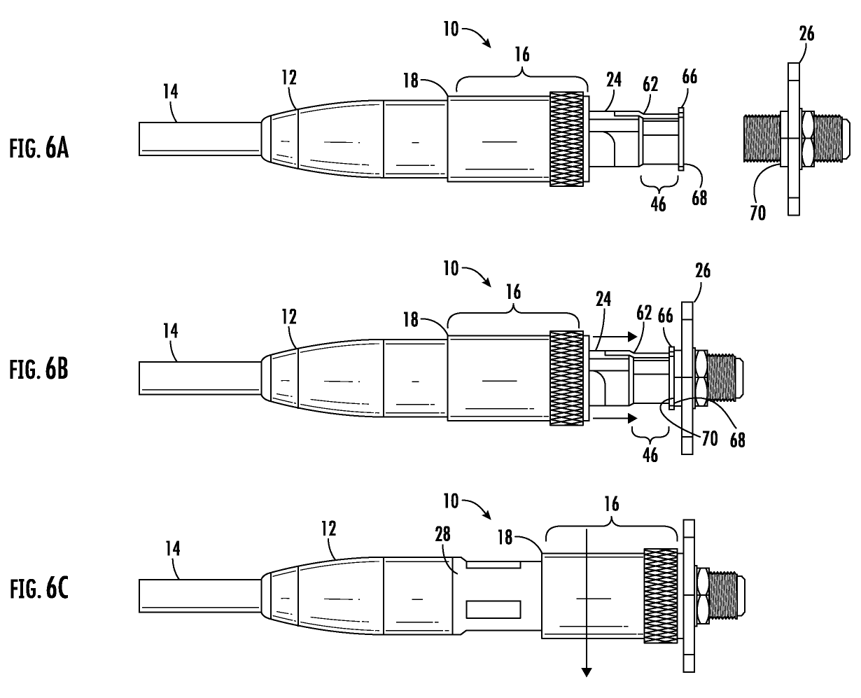

FIGS. 6A-6C are side views of the quick connect connector 10 at successive points in time as the quick connect connector 10 is connected to the externally threaded connector 26. Referring first to FIG. 6A, the coupling nut assembly 16 is initially in the uncoupled position with the inner ring 20 contacting the section 56 of the coupling component 24.

FIG. 6B is a side-view of the quick connect connector 10 illustrating the coupling component 24 engaging the externally threaded connector 26. To transition from the state illustrated in FIG. 6A to the state illustrated in FIG. 6B, the technician may grasp the body 12 behind the coupling nut assembly 16 and urges the quick connect connector 10 toward the externally threaded connector 26. As the chamfered interior surfaces 66 of the extensions 46 impact the externally threaded connector 26, the plurality of extensions 46 pivot away from the longitudinal axis. As the coupling component 24 is continually urged in the forward direction the plurality of extensions 46 may iteratively pivot away from the longitudinal axis 51 and pivot back toward the longitudinal axis 51 as the threads of the threaded internal surfaces 54 ride over the threads of the externally threaded connector 26 and then drop in between the threads of the externally threaded connector 26, eliminating the need to screw the coupling component 24 to the externally threaded connector 26. The end surface 68 of the coupling component 24 contacts the surface 70 of the externally threaded connector 26 inhibits further forward progress. In the case of a coaxial connector, the center pin 32 is now inserted into the externally threaded connector 26 and the threaded internal surface 54 of the plurality of extensions 46 are engaged with the externally threaded connector 26.

FIG. 6C is a side-view of the quick connect connector 10 illustrating the coupling nut assembly 16 in the coupled position. To transition from the state illustrated in FIG. 6B to the state illustrated in FIG. 6C, the technician grasps the coupling nut assembly 16 and slides the coupling nut assembly 16 across the body 12 and the coupling component 24. The coupling nut assembly 16 first transitions from the uncoupled position with the inner ring 20 contacting the section 56 of the coupling component 24 to the transition position with the inner ring 20 contacting the section 58 of the coupling component 24, thereby contacting the plurality of extensions 46. During transitioning, the larger diameter of the section 58 relative to the diameter of the section 56 causes the inner ring 20 to increase in diameter via the gap 74 in the inner ring 20. Further urging by the technician causes the coupling nut assembly 16 to slide to the coupled position wherein the inner ring 20 contacting the section 60 of the coupling component 24. When the inner ring 20 slides from the section 58 to the section 60, the inner ring 20 decreases in diameter via the gap 74. The annular recess 61 formed by the section 60 retains the inner ring 20 in contact with the section 60, preserving the coupling nut assembly 16 in the coupled position.

The coupling nut assembly 16 may now be rotated with respect to the body 12. As a rotational force is applied to the casing 18 to rotate the casing 18, the first detents 76 of the casing 18 contact the spring 22, causing the spring 22 to rotate together with the casing 18. As the spring 22 rotates, the spring 22 contacts the second detents 78 of the inner ring 20, causing the inner ring 20 to rotate together with the casing 18 and the spring 22. The protrusions 64 on the plurality of extensions 46 interlock with the recesses 72 on the inner ring 20 to cause the coupling nut assembly 16 to enter into a latched position with the coupling component 24. When the coupling nut assembly 16 is in the latched position with the coupling component 24, the coupling nut assembly 16 and the coupling component 24 are operable to rotate together. As the coupling component 24 is rotated, the threaded internal surface 54 further engages with the externally threaded connector 26 to tighten the threaded connection between the coupling component 24 and the externally threaded connector 26. The technician may continue to apply an increasing level of torque to the coupling nut assembly 16 such that the torque exceeds a predetermined threshold torque and the coupling nut assembly 16 releases from the latched position with the coupling component 24. In particular, when the torque threshold is exceeded, the protrusions 64 break from the interlock with the recesses 72, allowing rotation of the coupling nut assembly 16 with respect to the body 12 and the coupling component 24. The separation of the protrusions 64 and the recesses 72 can provide tactile feedback indicating to the technician that the quick connect connector 10 has been fully engaged with the externally threaded connector 26, such that a secure and reliable electrical coupling between the external component 14 and the externally threaded connector 26 has been created.

Individuals will recognize improvements and modifications to the preferred examples of the disclosure. All such improvements and modifications are considered within the scope of the concepts disclosed herein and the claims that follow.

What is claimed is:

1. A quick connect connector, comprising:
a body;
a coupling component; and
a coupling nut assembly;
wherein a longitudinal axis extends through the body, the coupling component and the coupling nut assembly, and wherein the coupling component is connected to the body, the coupling component comprising a base portion and a plurality of extensions that extend from the base portion, the plurality of extensions having internal threads and being operable to pivot away from the longitudinal axis; and
the coupling nut assembly being slidably connected to the body and having an uncoupled position wherein the coupling nut assembly allows the plurality of extensions to be pivoted away from the longitudinal axis and a coupled position wherein an interior surface of the coupling nut assembly contacts the plurality of extensions to inhibit pivoting of the plurality of extensions away from the longitudinal axis.

2. The quick connect connector of claim 1, wherein the coupling nut assembly is operable to apply an inward force to the plurality of extensions to cause the plurality of extensions to pivot towards the longitudinal axis when the coupling nut assembly is in the coupled position.

3. The quick connect connector of claim 2, wherein the coupling nut assembly comprises a spring component operable to apply the inward force to the plurality of extensions.

4. The quick connect connector of claim 1, wherein the coupling nut assembly is rotatable with respect to the body.

5. The quick connect connector of claim 4, further comprising:
a protrusion on at least one extension of the plurality of extensions;
wherein the interior surface of the coupling nut assembly forms a recess; and
wherein the coupling nut assembly is operable to enter a latched position wherein the protrusion interlocks with the recess.

6. The quick connect connector of claim 5, wherein the coupling nut assembly and the coupling component are operable to rotate together when the coupling nut assembly is in the latched position.

7. The quick connect connector of claim 5, wherein the coupling nut assembly is operable to release from the latched position when a torque applied to the coupling nut assembly exceeds a torque threshold.

8. The quick connect connector of claim 7, wherein the coupling nut assembly further comprises an inner ring and a casing, the inner ring defining the interior surface of the coupling nut assembly and the casing defining an exterior surface of the coupling nut assembly.

9. The quick connect connector of claim 8, wherein the casing is rotatable with respect to the inner ring.

10. The quick connect connector of claim 8, wherein the coupling nut assembly further comprises a spring between the casing and the inner ring.

11. The quick connect connector of claim 10, further comprising:
a first detent on the casing that projects toward the longitudinal axis; and
a second detent on the inner ring that projects away from the longitudinal axis;
wherein the first detent and the second detent are operable to engage with the spring to cause the inner ring to rotate relative to the coupling component.

12. The quick connect connector of claim 1, wherein the coupling nut assembly comprises an inner ring and a casing, the inner ring defining the interior surface of the coupling nut assembly and the casing defining an exterior surface of the coupling nut assembly.

13. The quick connect connector of claim 1, wherein each respective extension of the plurality of extensions connects to the base portion at a respective connection link, and wherein each respective extension is operable to pivot at the respective connection link.

14. The quick connect connector of claim 1, wherein the internal threads of the plurality of extensions are operable to engage with corresponding exterior threads of a threaded connector.

15. The quick connect connector of claim 14, wherein the internal threads of the plurality of extensions are operable to engage more than 40% of a circumference of the threaded connector.

16. The quick connect connector of claim 1, wherein each respective extension of the plurality of extensions has a corresponding distal end, an interior surface of the distal end being unthreaded and comprising a chamfered surface.

17. The quick connect connector of claim 1, wherein the quick connect connector is a male coaxial connector.

18. A quick connect connector, comprising:
a body;
a coupling component; and
a coupling nut assembly;
wherein a longitudinal axis extends through the body, the coupling component and the coupling nut assembly, and wherein the coupling component is connected to the body, the coupling component comprising a base portion and a plurality of extensions that extend from the base portion, the plurality of extensions having internal threads and being operable to pivot away from the longitudinal axis; and
the coupling nut assembly being slidably connected to the body and having an uncoupled position wherein the internal threads are operable to be urged over external threads of a matching connector and a coupled position wherein an interior surface of the coupling nut assembly contacts the plurality of extensions to inhibit pivoting of the plurality of extensions away from the longitudinal axis.
